(19) United States
(12) Patent Application Publication
(10) Pub. No.: US 2024/0160620 A1
(43) Pub. Date: May 16, 2024

(54) TIME-SERIES DATA PROCESSING METHOD

(71) Applicant: NEC Corporation, Minato-ku, Tokyo (JP)

(72) Inventors: Naoki YOSHINAGA, Tokyo (JP); Daichi SATO, Tokyo (JP)

(73) Assignee: NEC Corporation, Minato-ku, Tokyo (JP)

(21) Appl. No.: 18/281,686

(22) PCT Filed: Mar. 19, 2021
(86) PCT No.: PCT/JP2021/011538

§ 371 Date: Sep. 12, 2023

(51) Int. Cl. G06F 16/23

(52) U.S. Cl. CPC G06F 16/2365

(57) ABSTRACT

A time-series data processing apparatus 100 according to the present invention includes a database 121 associating time-series data measured from a measurement target and operation state information indicating an operation state of the measurement target when this time-series data is measured, a conversion unit 122 configured to convert the time-series data into feature amount data individually per predetermined period and convert the feature amount data into corrected feature amount data, which is generated by individually correcting the feature amount data based on a time of a corresponding period, and an extraction unit 123 configured to extract the corrected feature amount data corresponding to the time-series data based on the operation state information associated with the time-series data.

### TECHNICAL FIELD

The present invention relates to a time-series data processing method, a time-series data processing apparatus, and a program.

### BACKGROUND ART

Time-series data, which is measurement values from various kinds of sensors, is analyzed, and occurrence of an abnormal state is detected and output, in industrial plants that manufacture energy (electricity, gas, clean water, and the like), chemical products (crude oil, gasoline, plastic, and the like), metal products (iron, semiconductors, and the like), mechanical products (automobiles, computers, and the like), food products, pharmaceutical products, and the like, and equipment such as information processing systems. For example, in Patent Literature 1, operation data, which is detection values from sensors set up in equipment in a production line such as a factory, is acquired, and an anomaly detection model is learned from the operation data in a normal condition. Then, an anomaly state is monitored by calculating an anomaly score of the operation data newly acquired from the equipment after that using the anomaly detection model, and, for example, notifying a user.

### CITATION LIST

### Patent Literature

[Patent Literature 1] Japanese Patent Application Laid-Open No. 2020-008997

### SUMMARY OF INVENTION

### Technical Problem

However, a measurement target such as a plant and equipment may operate in a plurality of operation states, which makes it difficult to detect an anomaly while taking the operation state into consideration and therefore can raise a problem that the accuracy of anomaly detection reduces. For example, in a case of a measurement target that operates in an operation state varying depending on time of day or a season, even when data acquired when the target is monitored is detected to be an anomaly in an actual operation state, this data may be determined to be normal in another operation state, and may be subjected to erroneous detection. This results in occurrence of a problem that the accuracy of anomaly detection reduces with respect to the measurement target that operates in the plurality of operation states.

In light thereof, an object of the present invention is to provide a time-series data processing method capable of solving the problem that the accuracy of anomaly detection reduces with respect to the measurement target that operates in the plurality of operation states, which is the above-described problem.

### Solution to Problem

A time-series data processing method according to one aspect of the present invention is configured to include
associating time-series data measured from a measurement target and operation state information indicating an operation state of the measurement target when this time-series data is measured,
converting the time-series data into feature amount data individually per predetermined period and converting the feature amount data into corrected feature amount data, the corrected feature amount data being generated by individually correcting the feature amount data based on a time of a corresponding period, and
extracting the corrected feature amount data corresponding to the time-series data based on the operation state information associated with the time-series data.

Further, a time-series data processing apparatus according to one aspect of the present invention is configured to include
a database associating time-series data measured from a measurement target and operation state information indicating an operation state of the measurement target when this time-series data is measured,
a conversion unit configured to convert the time-series data into feature amount data individually per predetermined period and convert the feature amount data into corrected feature amount data, the corrected feature amount data being generated by individually correcting the feature amount data based on a time of a corresponding period, and
an extraction unit configured to extract the corrected feature amount data corresponding to the time-series data based on the operation state information associated with the time-series data.

Further, a program according to one aspect of the present invention is configured to cause an information processing apparatus to perform processing, the information processing apparatus being accessible to a database associating time-series data measured from a measurement target and operation state information indicating an operation state of the measurement target when this time-series data is measured, the processing including
converting the time-series data into feature amount data individually per predetermined period and converting the feature amount data into corrected feature amount data, the corrected feature amount data being generated by individually correcting the feature amount data based on a time of a corresponding period, and
extracting the corrected feature amount data corresponding to the time-series data based on the operation state information associated with the time-series data.

### Advantageous Effects of Invention

By being configured in the above-described manner, the present invention can improve the accuracy of abnormality detection with respect to the measurement target that operates in the plurality of operation states.

### BRIEF DESCRIPTION OF DRAWINGS

FIG. 1 is a block diagram illustrating the configuration of a time-series data processing apparatus according to a first exemplary embodiment of the present invention.

FIG. 2 illustrates how time-series data is processed by the time-series data processing apparatus disclosed in FIG. 1.

FIG. 3 illustrates how the time-series data is processed by the time-series data processing apparatus disclosed in FIG. 1.

FIG. 4 illustrates how the time-series data is processed by the time-series data processing apparatus disclosed in FIG. 1.

FIG. 5 illustrates how the time-series data is processed by the time-series data processing apparatus disclosed in FIG. 1.

FIG. 6 illustrates how the time-series data is processed by the time-series data processing apparatus disclosed in FIG. 1.

FIG. 7 illustrates how the time-series data is processed by the time-series data processing apparatus disclosed in FIG. 1.

FIG. 8 is a flowchart illustrating an operation of the time-series data processing apparatus disclosed in FIG. 1.

FIG. 9 is a flowchart illustrating an operation of the time-series data processing apparatus disclosed in FIG. 1.

FIG. 10 is a block diagram illustrating the hardware configuration of a time-series data processing apparatus according to a second exemplary embodiment of the present invention.

FIG. 11 is a block diagram illustrating the configuration of the time-series data processing apparatus according to the second exemplary embodiment of the present invention.

FIG. 12 is a flowchart illustrating an operation of the time-series data processing apparatus according to the second exemplary embodiment of the present invention.

### DESCRIPTION OF EMBODIMENTS

### First Exemplary Embodiment

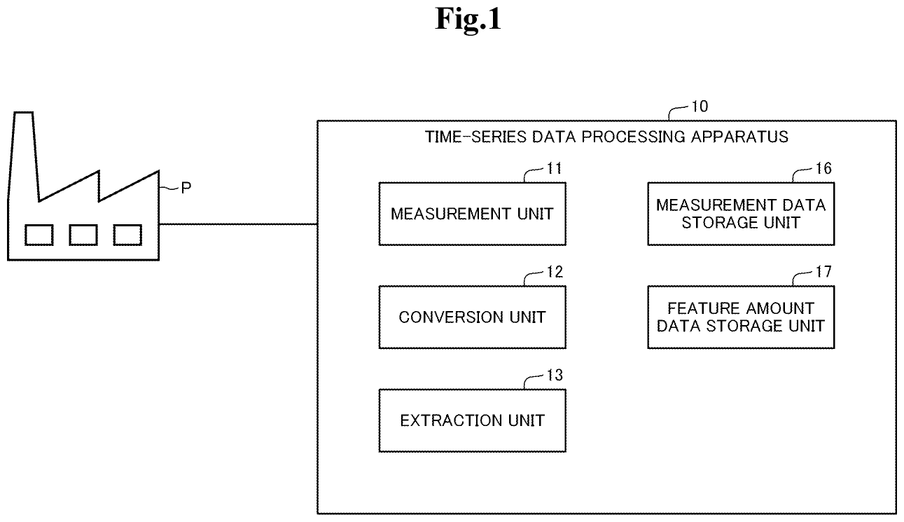

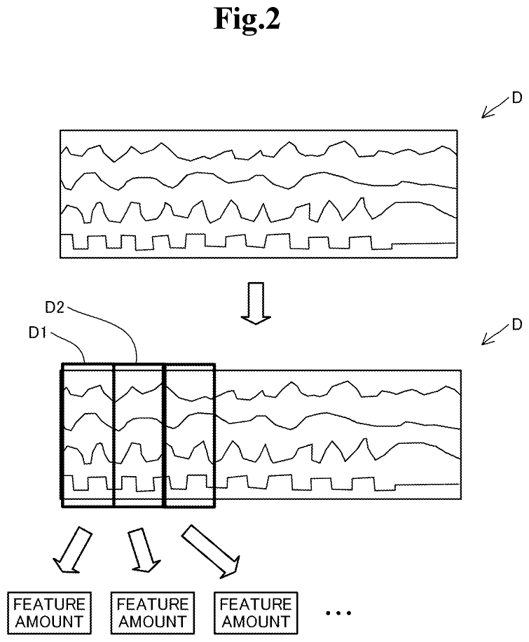

A first exemplary embodiment of the present invention will be described with reference to FIGS. 1 to 9. FIG. 1 is a diagram for illustrating the configuration of a time-series data processing apparatus, and FIGS. 2 to 9 are diagrams for illustrating processing operations of the time-series data processing apparatus.

### [Configuration]

A time-series data processing apparatus 10 according to the present invention is connected to a measurement target P such as a plant. Then, the time-series data processing apparatus 10 acquires and analyzes measurement values of at least one or more data items of the measurement target P, and monitors the state of the measurement target P based on a result of the analysis. For example, the measurement target P is a plant such as a manufacturing plant or a processing facility, and the respective measurement values of the data items include a plurality of kinds of data item values such as a temperature in the plant, a pressure, a flow rate, a power consumption value, and a supply amount and a remaining amount of a material. Then, in the present exemplary embodiment, assume that the state of the measurement target P that the time-series data processing apparatus 10 monitors is an abnormal state of the measurement target P. Therefore, assume that the time-series data processing apparatus 10 converts the measurement values constituted by the plurality of data items into a feature amount and further detects the abnormal state based on an abnormality degree calculated from this feature amount. However, the time-series data processing apparatus 10 according to the present exemplary embodiment does not necessarily have to perform as far as processing for detecting that the measurement target P is in the abnormal state, and may be configured to perform only processing for converting the measurement values into the feature amount and extracting this feature amount as pre-processing for detecting that the measurement target P is in the abnormal state, as will be described below.

Note that the measurement target P in the present invention is not limited to the plant, and may be anything including equipment such as an information processing system. For example, in the case where the measurement target P is an information processing system, the time-series data processing apparatus 10 may measure Central Processing Unit (CPU) utilization, memory utilization, disk access frequency, the number of input/output packets, an input/output packet rate, a power consumption value, and the like of each information processing apparatus such as a terminal and a server constituting the information processing system as the respective measurement values of the data items, and analyze these measurement values to monitor the state of the information processing system.

The time-series data processing apparatus 10 is configured of one or a plurality of information processing apparatus(es) each including an arithmetic unit and a storage unit. Then, the time-series data processing apparatus 10 includes an acquisition unit 11, a conversion unit 12, and an extraction unit 13 as illustrated in FIG. 1. Each of the functions of the acquisition unit 11, the conversion unit 12, and the extraction unit 13 can be realized through execution of a program for realizing each of the functions that is stored in the storage unit by the arithmetic unit. Further, the time-series data processing apparatus 10 includes a measurement data storage unit 16 and a feature amount data storage unit 17. The measurement data storage unit 16 and the feature amount data storage unit 17 are configured of the storage unit. Hereinafter, each configuration will be described in detail.

The acquisition unit 11 acquires the measurement value of each of the data items measured by various kinds of sensors set up in the measurement target P at predetermined time intervals as time-series data, and stores it into the measurement data storage unit 16. At this time, because there is a plurality of kinds of measured data items, the acquisition unit 11 acquires a time-series dataset D, which is a group of pieces of time-series data with respect to the plurality of data items as indicated by a line graph in FIG. 2. Assume that the horizontal axis represents time and each line represents the measurement value of each data item in the line graph in FIG. 2. Note that the acquisition 11 acquires and stores the time-series dataset D constantly, and the acquired time-series dataset D is used each when the feature amount data is cumulated while the measurement target P is in operation in a predetermined operation mode and when the state of the measurement target P is monitored, as will be described below.

Note that, with respect to the time-series dataset D used in the processing for cumulating the feature amount data acquired when the measurement target P is in operation in the predetermined operation mode, the acquisition unit 11 stores it into the measurement data storage unit 16 (a database) in association with an operation mode (operation state information), which indicates the operation state of the measurement target P when this time-series dataset D is measured, and a machine type (type information), which indicates the type of the measurement target P, as will be described below. For example, the operation mode is information indicating a time frame (morning, afternoon, early evening, or the like), a month (January, February, or the like), or a season (for example, spring, summer, fall, or winter) in which the measurement target P operates, or an operation state after a startup (for example, when the measurement target P is started up or while the measurement target P is in regular operation). Further, when a plurality of types of measurement targets P is present, the machine type indicates the type of this machine (for example, a machine type A, B, or C). Then, as the operation mode and the machine type, for example, the acquisition unit 11 may acquire information about an operation mode and a machine type input by an operator when the measurement target P operates and store them in association with the time-series dataset D, or may acquire information about an operation mode and a machine type already set to the measurement target P in operation and store them in association with the time-series dataset D.

The conversion unit 12 converts the time-series dataset stored in the measurement data storage unit 16 into the feature amount data constituted by information indicating a feature of this time-series dataset D. At this time, the conversion unit 12 generates partial time-series datasets D1 and D2 constituted by predetermined periods by dividing the time-series dataset D per predetermined time as indicated by reference numerals D1 and D2 in FIG. 2, and converts these partial time-series datasets D1 and D2 into pieces of feature amount data, respectively. Note that the periods of the plurality of partial time-series datasets D1 and D2 may be continuous to each other without any interval therebetween, may overlap each other, or may be separated from each other via a time interval.

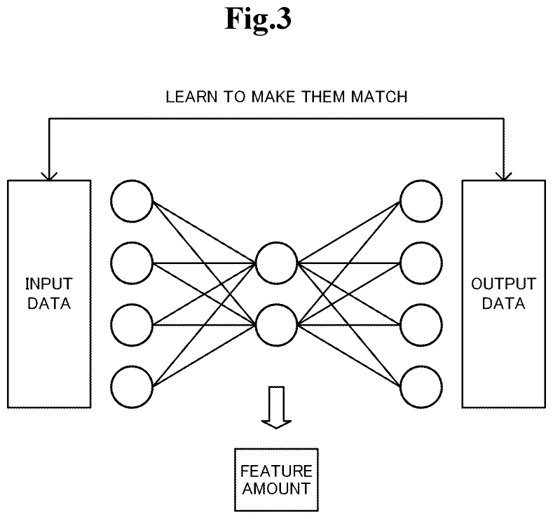

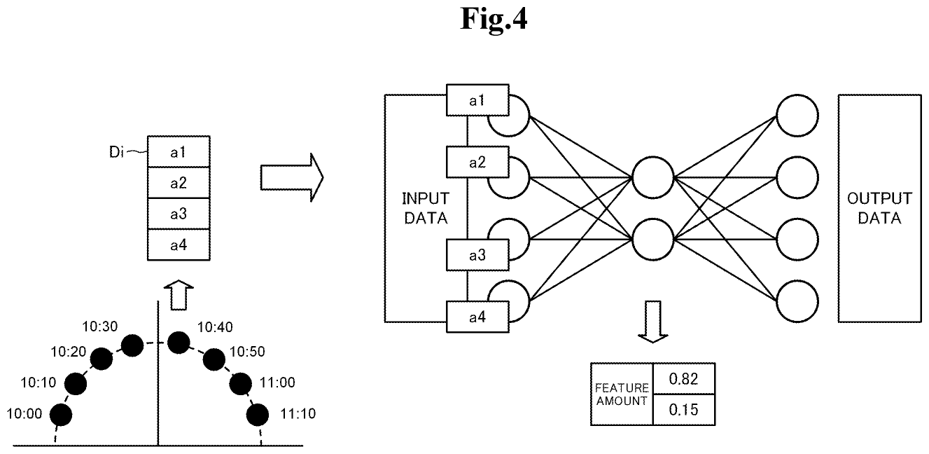

More specifically, the conversion unit 12 converts the partial time-series dataset into the feature amount using an autoencoder constructed by unsupervised learning. The autoencoder is intended to, in response to the partial time-series dataset as input data, output output data that matches this input data as illustrated in FIG. 3. At this time, in the autoencoder, the dimension of the input data is compressed in an intermediate layer located between an input layer into which the input data is input and an output layer from which the output data is output, and a value in this intermediate layer is used as the feature amount data of the input data, i.e., the partial time-series dataset. The example in FIG. 3 indicates that the input layer is constituted by four nodes and the intermediate layer is constituted by two nodes. For example, if a partial time-series dataset Di in a period corresponding to a time “10:40” is constituted by four values (a1, a2, a3, a4), the autoencoder is supposed to convert this data into feature amount data constituted by two values (0.82, 0.15) as illustrated in FIG. 4. Note that the conversion unit 12 is assumed to use the autoencoder generated by, for example, conducting machine learning of a partial time-series dataset measured from the measurement target P when the measurement target P has been in normal operation previously. In other words, the autoencoder is constructed by learning weighting between the nodes so as to output the matching output data in response to the partial time-series dataset measured from the measurement target P when the measurement target P has been in normal operation as the input data. However, the conversion unit 12 is not necessarily limited to converting the partial time-series dataset into the feature amount data using the autoencoder, and may convert the partial time-series dataset into the feature amount data using another method.

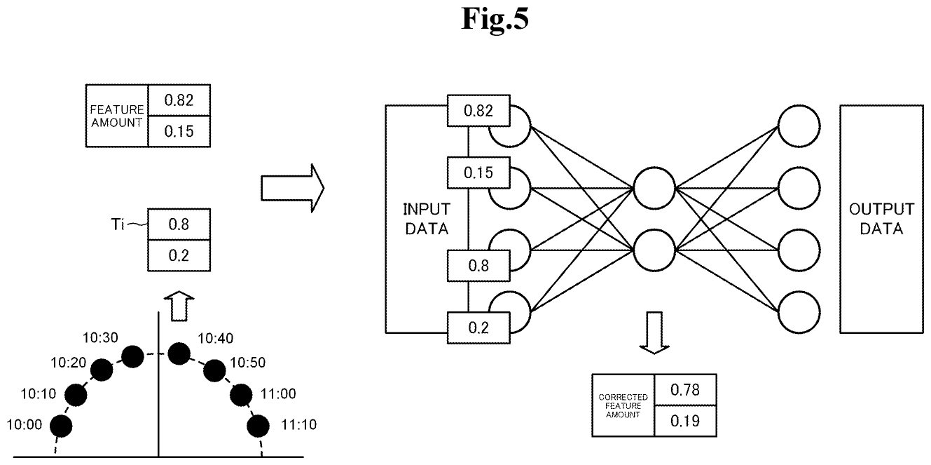

Further, the conversion unit 12 has a function of converting the feature amount data converted from the partial time-series dataset as described above into further corrected feature amount data, and stores the converted corrected feature amount data into the feature amount data storage unit 17. At this time, the conversion unit 12 corrects the feature amount data based on a time at which the partial time-series dataset before the conversion into this feature amount data is measured, and converts it into the corrected feature amount data. More specifically, the conversion unit 12 adds time data expressed by a value based on the time at which the partial time-series dataset corresponding to this feature amount data is measured to the feature amount data, and converts the feature amount data with this time data added thereto into the corrected feature amount data using an autoencoder. At this time, assume that the time data is added to the feature amount data using such data that, as the times are closer, the values are more similar. As one example, assume that times at which partial time-series datasets are measured are arranged on a circle perimeter in order in such a manner that closer times are located closer to each other, and two values such as (sin θ, cos θ), which are trigonometric ratios according to the angle of this time, are used as the time data, as illustrated at the lower left of FIG. 5. In the example in FIG. 5, for example, (0.8, 0.2), which are values of the trigonometric ratios corresponding to the position on the circle perimeter at which the time “10:40” is arranged, are used as time data Ti. Then, the conversion unit 12 inputs four values (0.82, 0.15, 0.8, 0.2), which are the feature amount data (0.82, 0.15) converted from the partial time-series dataset at the time “10:40” with the time data Ti (0.8, 0.2) added thereto, into the autoencoder as input data. As a result, the conversion unit 12 can acquire a value in an intermediate layer of the autoencoder, which is trained by machine learning so as to output output data that matches the input data, as the corrected feature amount data. Note that a value different on a yearly basis, like “month and date”, may be used as the time. This means that the pieces of time data in this case have more similar values as their “months and dates” are closer.

Then, the above-described pieces of time data are each set to values (sin θ, cos θ), which are the trigonometric ratios according to the position of the time arranged on the circle perimeter in order, and therefore have more similar values as their times are closer. Accordingly, pieces of time data having similar values are added to pieces of feature amount data of partial time-series datasets corresponding to periods close to each other, respectively, and therefore the pieces of input data input to the autoencoder also have similar values. Especially, partial time-series datasets measured from the measurement target P when the measurement target P operates normally are expected to less change as their times are closer, and therefore pieces of feature amount data thereof are considered to also have similar values. Then, being generated by adding the time data to this feature amount data, the input data itself can be expected to have similar values. As a result, the pieces of corrected feature amount data, which are values in the intermediate layer of the autoencoder, can have more similar values as the datasets corresponding thereto are measured at closer times. Note that the conversion unit 12 is assumed to use the autoencoder generated by conducting machine learning based on the value acquired by adding the time data to the feature amount data converted in the above-described manner as the input data using the partial time-series dataset measured from the measurement target P when the measurement target P has been in normal operation previously. However, the conversion unit 12 is not necessarily limited to converting the feature amount data with the time data added thereto into the corrected feature amount data using the autoencoder, and may convert the feature amount data into the corrected feature amount data by any method. For example, the above-described time data is one example, and the time data may be other data based on the time at which the partial time-series dataset is measured and the feature amount data may be corrected into the corrected feature amount data based on the time by any method.

Note that, when the measurement target P is monitored, the conversion unit 12 performs only processing for converting a time-series dataset newly measured from this measurement target P (second time-series data) into the feature amount data (second feature amount data) in the above-described manner. In other words, when the measurement target P is monitored, the conversion unit 12 divides the time-series dataset D into the partial time-series datasets D1 and D2 and inputs each of the partial time-series datasets D1 and D2 into the autoencoder, thereby converting them into the feature amount data as described above. At this time, the conversion unit 12 does not convert the feature amount data into the further corrected corrected feature amount data.

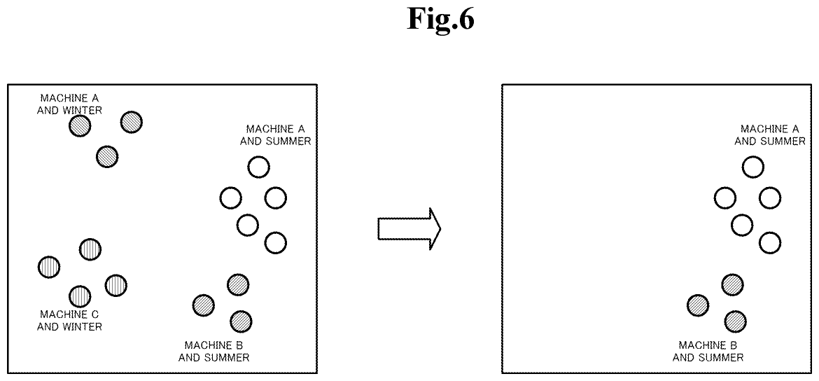

The extraction unit 13 provides an output so as to extract and display the corrected feature amount data stored in the feature amount data storage unit 17 based on the operation mode and/or the machine type associated with the time-series dataset from which this corrected feature amount data is derived. For example, when the operation mode and/or the machine type are/is specified by an instruction from the operator, the extraction unit 13 provides an output so as to extract and display only the corrected feature amount data converted from the partial time-series dataset in association with the specified operation mode and/or machine type by referring to the data stored in the measurement data storage unit 16. For example, the left side of FIG. 6 illustrates an example that displays the corrected feature amount data corresponding to each operation mode (summer and winter) and each machine type (A, B, and C). Then, when “summer” is specified as the operation mode, only corrected feature amount data corresponding to the operation mode “summer” is extracted and displayed as illustrated on the right side of FIG. 6. Note that the extraction unit 13 extracts the corrected feature amount data corresponding to the specified operation mode and machine type when the operation mode and the machine type are specified, and extracts the corrected feature amount data corresponding to the specified machine type when only the machine type is specified.

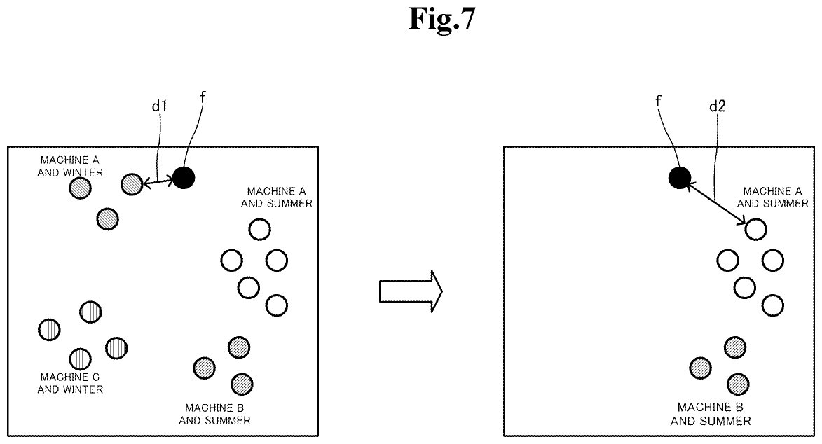

Further, the extraction unit 13 also has a function of performing processing for, when the measurement target P is monitored, comparing the feature amount data (the second feature amount data) of the time-series data newly measured from this measurement target P (the second time-series data) with the corrected feature amount data extracted by being specified by the operator. For example, the left side of FIG. 7 illustrates an example that displays and compares all pieces of corrected feature amount data and feature amount data f converted from the newly measured time-series data on the same screen. In this case, the abnormality degree of the feature amount data f is supposed to be calculated as a value based on a distance d1 from corrected feature amount data corresponding to the closest machine type “A” and operation mode “winter”. However, when the newly measured time-series data is data measured when the machine type “A” is in operation in the operation mode “summer”, it is desirable that the abnormality degree of the feature amount data f is calculated as a value based on a distance d2 from corrected feature amount data corresponding to the machine type “A” and the operation mode “summer”. Therefore, the operator's specifying “summer” as the operation mode causes the extraction unit 13 to extract and display only the corrected feature amount data corresponding to this operation mode as illustrated on the right side of FIG. 7, and allows the extraction unit 13 to calculate the value based on the distance d2 from the corrected feature amount data corresponding to the machine type “A” and the operation mode “summer” as the abnormality degree of the feature amount data f. Note that the extraction unit 13 may automatically calculate and compare the abnormality degree of the new feature amount data fin relation to the extracted corrected feature amount data, or may just display the extracted corrected feature amount data and the feature amount data f so as to allow them to be compared as illustrated on the right side of FIG. 7.

### [Operation]

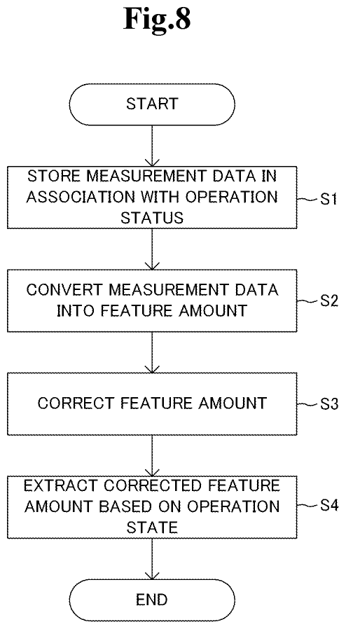

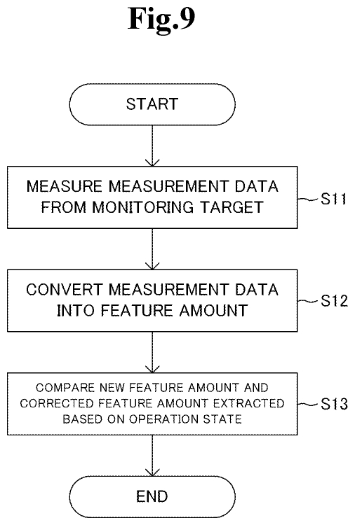

Next, operations of the above-described time-series data processing apparatus 10 will be described mainly with reference to flowcharts of FIGS. 8 and 9. First, an operation when the feature amount data is cumulated with the measurement target P in normal operation in a predetermined operation mode will be described with reference to the flowchart of FIG. 8.

First, the time-series data processing apparatus 10 acquires the measurement value of each of the data items measured by the various kinds of sensors set up in the measurement target P at the predetermined time intervals as the time-series dataset, and stores it into the measurement data storage unit 16. At this time, the time-series data processing apparatus 10 stores the acquired time-series dataset into the measurement data storage unit 16 in association with the information about the operation mode indicating the operation state of the measurement target P and the machine type indicating the type of the measurement target P (step S1).

Subsequently, the time-series data processing apparatus 10 converts the time-series dataset stored in the measurement data storage unit 16 into the feature amount data constituted by the information indicating the feature of this time-series dataset (step S2). At this time, the time-series data processing apparatus 10 divides the time-series dataset D into the partial time-series datasets D1 and D2, which are constituted by the predetermined periods separated per predetermined time, as indicated by the reference numerals D1 and D2 in FIG. 2, and converts these partial time-series datasets D1 and D2 into the pieces of feature amount data, respectively. For example, the time-series data processing apparatus 10 converts the partial time-series dataset into the feature amount data using the autoencoder constructed by unsupervised learning. The autoencoder is intended to, in response to the partial time-series dataset as the input data, output the output data that matches this input data as illustrated in FIG. 3. In other words, the time-series data processing apparatus 10 inputs the partial time-series dataset as the input data of the autoencoder, thereby acquiring the value in the intermediate layer into which the dimension of this input data is compressed as the feature amount data.

Subsequently, the time-series data processing apparatus 10 converts the feature amount data converted from the partial time-series dataset into the further corrected corrected feature amount data, and stores the corrected feature amount data into the feature amount data storage unit 17 (step S3). At this time, the time-series data processing apparatus 10 corrects the feature amount data based on the time at which the partial time-series dataset before the conversion into this feature amount data is measured, and converts it into the corrected feature amount data. More specifically, the time-series data processing apparatus 10 adds the time data expressed by the value based on the time at which the partial time-series dataset corresponding to this feature amount data is measured to the feature amount data, and converts the feature amount data with this time data added thereto into the corrected feature amount data using the autoencoder. Especially, assume that the time data is added to the feature data using such data that, as the times are closer, the values are more similar. This means that pieces of feature amount data of partial time-series datasets corresponding to times close to each other are converted into pieces of corrected feature amount data having values similar to each other. Note that, by using the autoencoder constructed by unsupervised learning that is intended to, in response to the feature amount data with the time data added thereto as the input data, output the output data that matches this input data, the time-series data processing apparatus 10 acquires the value in the intermediate layer thereof as the corrected feature amount data.

Then, the time-series data processing apparatus 10 provides an output so as to extract and display the corrected feature amount data stored in the feature amount data storage unit 17 based on the operation mode and/or the machine type associated with the time-series dataset from which this corrected feature amount data is derived (step S4). For example, when “summer” is specified as the operation mode, the time-series data processing apparatus 10 extracts and displays only corrected feature amount data corresponding to this operation mode as illustrated on the right side of FIG. 6. Note that the time-series data processing apparatus 10 extracts the corrected feature amount data corresponding to the specified operation mode and machine type when the operation mode and the machine type are specified, and extracts the corrected feature amount data corresponding to the specified machine type when only the machine type is specified.

In this manner, the time-series data processing apparatus 10 according to the present invention further corrects the feature amount data of the partial time-series dataset based on the time, thereby allowing the pieces of corrected feature amount data corresponding to close times to have further similar values. As a result, the time-series data processing apparatus 10 can further accurately cluster the pieces of corrected feature amount data when they are acquired in the same operation state such as the operation mode and the machine type.

Next, an operation when the operation state of the measurement target P is monitored will be described with reference to the flowchart of FIG. 9. First, the time-series data processing apparatus 10 acquires the measurement value of each of the data items measured by the various kinds of sensors set up in the measurement target P, which is subjected to the monitoring of the operation state, at the predetermined time intervals as the time-series dataset (step S11). Then, the time-series data processing apparatus 10 sequentially divides the time-series dataset per predetermined time into the partial time-series datasets D1 and D2 as illustrated in FIG. 2, and converts these partial time-series datasets into the pieces of feature amount data, respectively (step S12). For example, as described above, the time-series data processing apparatus 10 inputs the partial time-series dataset to the autoencoder and acquires the value in the intermediate layer thereof as the feature amount data as illustrated in FIG. 3.

After that, the time-series data processing apparatus 10 compares the corrected feature amount data stored in the feature amount data storage unit 17 and the feature amount data converted from the newly measured partial time-series dataset as described above (step S13). For example, the time-series data processing apparatus 10 extracts and displays only the corrected feature amount data corresponding to the present operation mode of the presently monitored measurement target P and the same machine type as it, and also displays the feature amount data converted from the newly measured time-series data along therewith. This display allows the feature amount data of the presently monitored measurement target P to be compared with the corrected feature amount data under normal conditions that is acquired when the measurement target P is in the same operation state. As a result, the feature amount data converted from the measurement data when the measurement target P is monitored can be compared with the accurately clustered feature amount data in the same operation state as the operation state of this measurement target P, which can contribute to suppressing erroneous detection of an abnormal state of the measurement target P, thereby improving the abnormality detection accuracy.

### Second Exemplary Embodiment

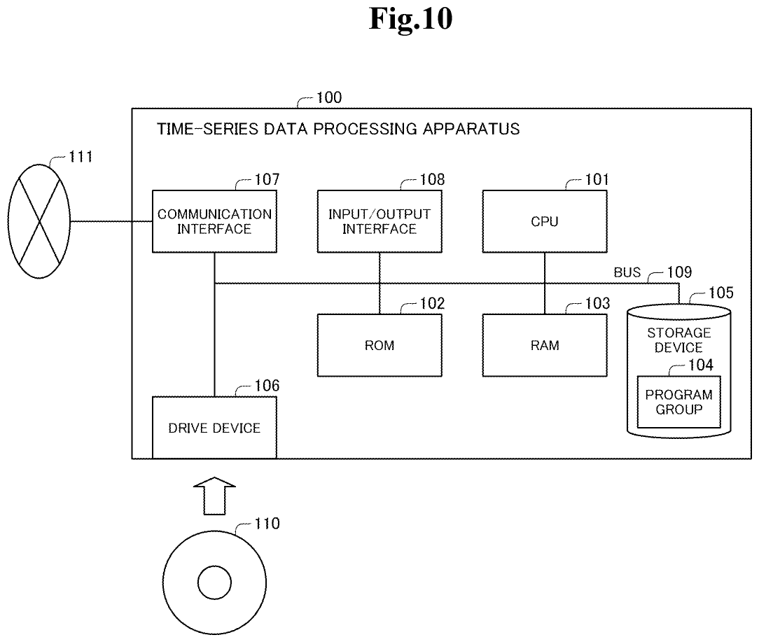

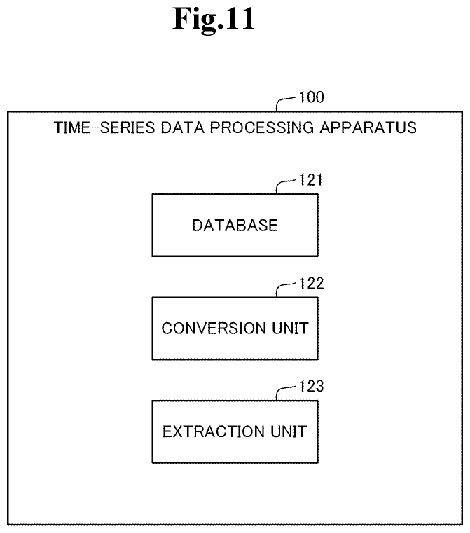

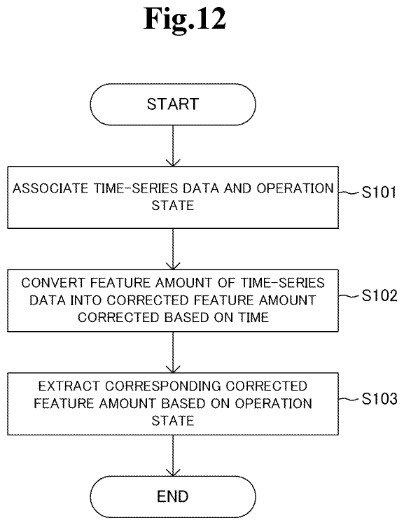

Next, a second exemplary embodiment of the present invention will be described with reference to FIGS. 10 to 12. FIGS. 10 and 11 are block diagrams illustrating the configuration of a time-series data processing apparatus according to the second exemplary embodiment, and FIG. 12 is a flowchart illustrating an operation of the time-series data processing apparatus. Note that the present exemplary embodiment indicates the outlines of the time-series data processing apparatus and the time-series data processing method described in the above-described exemplary embodiment.

First, the hardware configuration of a time-series data processing apparatus 100 according to the present exemplary embodiment will be described with reference to FIG. 10. The time-series data processing apparatus 100 is configured of a commonly-used information processing apparatus, and has the following hardware configuration as one example.
Central Processing Unit (CPU) 101 (arithmetic unit)
Read Only Memory (ROM) 102 (storage unit)
Random Access Memory (RAM) 103 (storage unit)
Program group 104 to be loaded into the RAM 103
Storage device 105 storing therein the program group 104
Drive device 106 in charge of reading from and writing into a storage medium 110 outside the information processing apparatus
Communication interface 107 connected to a communication network 111 outside the information processing apparatus
Input/output interface 108 in charge of an input/output of data
Bus 109 connecting each constituent element

Then, the time-series data processing apparatus 100 can construct and include a database 121, a conversion unit 122, and an extraction unit 123 illustrated in FIG. 11 through acquisition of the program group 104 and execution thereof by the CPU 101. Note that the program group 104 is, for example, stored in the storage device 105 or the ROM 102 in advance, and is loaded into the RAM 103 and executed by the CPU 101 as needed. Alternatively, the program group 104 may be supplied to the CPU 101 via the communication network 111, or may be stored in the storage medium 110 in advance and read out by the drive device 106 and supplied to the CPU 101. However, the above-described database 121, conversion unit 122, and extraction unit 123 may be constructed by electronic circuits designed specifically for realizing these functions.

Note that FIG. 10 illustrates one example of the hardware configuration of the information processing apparatus that is the time-series data processing apparatus 100, and the hardware configuration of the information processing apparatus is not limited to the above-described example. For example, the information processing apparatus may be configured of a part of the above-described configuration, such as a configuration not including the drive device 106.

Then, the time-series data processing apparatus 100 performs a time-series data processing method illustrated in the flowchart of FIG. 12 by the functions of the database 121, the conversion unit 122, and the extraction unit 123 constructed by the program as described above.

As illustrated in FIG. 12, the time-series data processing apparatus 100 performs processing of
associating time-series data measured from a measurement target and operation state information indicating an operation state of the measurement target when this time-series data is measured (step S101);
converting the time-series data into feature amount data individually per predetermined period and converting the feature amount data into corrected feature amount data, which is generated by correcting the feature amount data based on a time of a corresponding period (step S102); and
extracting the corrected feature amount data corresponding to the time-series data based on the operation state information associated with the time-series data (step S103).

Note that the above-described program can be stored using various types of non-transitory computer readable media and supplied to a computer. The non-transitory computer readable media include various types of tangible storage media. Examples of the non-transitory computer readable media include a magnetic recording medium (for example, a flexible disk, a magnetic tape, and a hard disk drive), a magneto-optical recording medium (for example, a magneto-optical disk), a CD-Read Only Memory (ROM), a CD-R, a CD-R/W, a semiconductor memory (for example, a mask ROM, a Programmable ROM (PROM), an Erasable PROM (EPROM), a flash ROM, and a Random Access Memory (RAM)). Alternatively, the program may also be supplied to the computer via various types of transitory computer readable media. Examples of the transitory computer readable media include electric signals, optical signals, and electromagnetic waves. The transitory computer readable media can supply the program to the computer via a wired communication channel such as an electric wire and an optical fiber, or a wireless communication channel.

Having described the present invention with reference to the above-described exemplary embodiments and the like, the present invention is not limited to the above-described exemplary embodiments. The form and details of the present invention can be changed within the scope of the present invention in various manners that can be understood by those skilled in the art. Further, at least one or more functions among the functions of the above-described database 121, conversion unit 122 and extraction unit 123 may be executed by an information processing apparatus set up at any location in a network and connected therefrom, i.e., may be executed by so-called cloud computing.

### <Supplementary Notes>

The whole or part of the exemplary embodiments disclosed above can also be described as, but not limited to, the following supplementary notes. Hereinafter, the outlines of the configurations of a time-series data processing method, a time-series data processing apparatus, and a program according to the present invention will be described. However, the present invention is not limited to the following configurations.

### (Supplementary Note 1)

A time-series data processing method comprising:
associating time-series data measured from a measurement target and operation state information indicating an operation state of the measurement target when this time-series data is measured;
converting the time-series data into feature amount data individually per predetermined period and converting the feature amount data into corrected feature amount data, the corrected feature amount data being generated by individually correcting the feature amount data based on a time of a corresponding period; and
extracting the corrected feature amount data corresponding to the time-series data based on the operation state information associated with the time-series data.

### (Supplementary Note 2)

The time-series data processing method according to supplementary note 1, further comprising:
converting the feature amount data corresponding to each predetermined period into the corrected feature amount data in such a manner that this corrected feature amount data, in relation to the corrected feature amount data corresponding to another period, has a value according to closeness of the time to this other period.

### (Supplementary Note 3)

The time-series data processing method according to supplementary note 1 or 2, further comprising:
converting the feature amount data corresponding to each predetermined period into the corrected feature amount data in such a manner that this corrected feature amount data has a value more similar to the corrected feature amount data corresponding to the other period as the time is closer to the other period.

### (Supplementary Note 4)

The time-series data processing method according to any of supplementary notes 1 to 3, further comprising:
adding time data having a value based on the time of the corresponding period to the feature amount data corresponding to each predetermined period, and converting the feature amount data with this time data added thereto into the corrected feature amount data.

### (Supplementary Note 5)

The time-series data processing method according to supplementary note 4, further comprising:
adding the time data, which is set in such a manner that, as the times of the corresponding periods are closer, the values are more similar, to the feature amount data corresponding to each predetermined period, and converting the feature amount data with this time data added thereto into the corrected feature amount data.

### (Supplementary Note 6)

The time-series data processing method according to supplementary note 4 or 5, further comprising:
converting the time-series data into the feature amount data per predetermined time using an autoencoder, and converting the feature amount data with the time data added thereto into the corrected feature amount data using an autoencoder.

### (Supplementary Note 7)

The time-series data processing method according to any of supplementary notes 1 to 6, further comprising:
converting second time-series data measured from the measurement target into second feature amount data; and
performing processing for comparing the corrected feature amount data extracted based on the operation state information with the second feature amount data.

### (Supplementary Note 8)

The time-series data processing method according to supplementary note 7, further comprising:
extracting the corrected feature amount data corresponding to the time-series data associated with the selected operation state information.

### (Supplementary Note 9)

The time-series data processing method according to any of supplementary notes 1 to 8, wherein
the operation state information includes information indicating an operation mode when the measurement target operates.

### (Supplementary Note 10)

The time-series data processing method according to any of supplementary notes 1 to 9, further comprising:
associating the time-series data and type information indicating a type of the measurement target; and
extracting, based on the type information associated with the time-series data, the corrected feature amount data corresponding to this time-series data.

### (Supplementary Note 11)

A time-series data processing apparatus comprising:
a database associating time-series data measured from a measurement target and operation state information indicating an operation state of the measurement target when this time-series data is measured;
a conversion unit configured to convert the time-series data into feature amount data individually per predetermined period and convert the feature amount data into corrected feature amount data, the corrected feature amount data being generated by individually correcting the feature amount data based on a time of a corresponding period; and
an extraction unit configured to extract the corrected feature amount data corresponding to the time-series data based on the operation state information associated with the time-series data.

### (Supplementary Note 12)

The time-series data processing apparatus according to supplementary note 11, wherein
the conversion unit converts the feature amount data corresponding to each predetermined period into the corrected feature amount data in such a manner that this corrected feature amount data, in relation to the corrected feature amount data corresponding to another period, has a value according to closeness of the time to this other period.

### (Supplementary Note 13)

The time-series data processing apparatus according to supplementary note 11 or 12, wherein
the conversion unit converts the feature amount data corresponding to each predetermined period into the corrected feature amount data in such a manner that this corrected feature amount data has a value more similar to the corrected feature amount data corresponding to the other period as the time is closer to the other period.

### (Supplementary Note 14)

The time-series data processing apparatus according to any of supplementary notes 11 to 13, wherein
the conversion unit adds time data having a value based on the time of the corresponding period to the feature amount data corresponding to each predetermined period, and converts the feature amount data with this time data added thereto into the corrected feature amount data.

### (Supplementary Note 15)

The time-series data processing apparatus according to supplementary note 14, wherein
the conversion unit adds the time data, which is set in such a manner that, as the times of the corresponding periods are closer, the values are more similar, to the feature amount data corresponding to each predetermined period, and converts the feature amount data with this time data added thereto into the corrected feature amount data.

### (Supplementary Note 16)

The time-series data processing apparatus according to supplementary note 14 or 15, wherein
the conversion unit converts the time-series data into the feature amount data per predetermined time using an autoencoder, and converts the feature amount data with the time data added thereto into the corrected feature amount data using an autoencoder.

### (Supplementary Note 17)

The time-series data processing apparatus according to any of supplementary notes 11 to 16, wherein
the conversion unit converts second time-series data measured from the measurement target into second feature amount data, and
the extraction unit performs processing for comparing the corrected feature amount data extracted based on the operation state information with the second feature amount data.

### (Supplementary Note 18)

The time-series data processing apparatus according to supplementary note 17, wherein
the extraction unit extracts the corrected feature amount data corresponding to the time-series data in association with the selected operation state information.

### (Supplementary Note 19)

The time-series data processing apparatus according to any of supplementary notes 11 to 18, wherein
the database stores data in which the time-series data and type information indicating a type of the measurement target are associated with each other, and
the extraction unit extracts, based on the type information associated with the time-series data, the corrected feature amount data corresponding to this time-series data.

### (Supplementary Note 20)

A program causing an information processing apparatus to perform processing, the information processing apparatus being accessible to a database associating time-series data measured from a measurement target and operation state information indicating an operation state of the measurement target when this time-series data is measured, the processing comprising:
converting the time-series data into feature amount data individually per predetermined period and converting the feature amount data into corrected feature amount data, the corrected feature amount data being generated by individually correcting the feature amount data based on a time of a corresponding period; and
extracting the corrected feature amount data corresponding to the time-series data based on the operation state information associated with the time-series data.

### REFERENCE SIGNS LIST

10 time-series data processing apparatus
11 acquisition portion
12 conversion unit
13 extraction unit
16 measurement data storage unit
17 feature amount data storage unit
100 time-series data processing apparatus
101 CPU
102 ROM
103 RAM
104 program group
105 storage device
106 drive device
107 communication interface
108 input/output interface
109 bus
110 storage medium
111 communication network
121 database
122 conversion unit
123 extraction unit

What is claimed is:

1. A time-series data processing method comprising:
associating time-series data measured from a measurement target and operation state information indicating an operation state of the measurement target when this time-series data is measured;
converting the time-series data into feature amount data individually per predetermined period and converting the feature amount data into corrected feature amount data, the corrected feature amount data being generated by individually correcting the feature amount data based on a time of a corresponding period; and
extracting the corrected feature amount data corresponding to the time-series data based on the operation state information associated with the time-series data.

2. The time-series data processing method according to claim 1, further comprising:
converting the feature amount data corresponding to each predetermined period into the corrected feature amount data in such a manner that this corrected feature amount data, in relation to the corrected feature amount data corresponding to another period, has a value according to closeness of the time to this other period.

3. The time-series data processing method according to claim 1, further comprising:
converting the feature amount data corresponding to each predetermined period into the corrected feature amount data in such a manner that this corrected feature amount data has a value more similar to the corrected feature amount data corresponding to the other period as the time is closer to the other period.

4. The time-series data processing method according to claim 1, further comprising:
adding time data having a value based on the time of the corresponding period to the feature amount data corresponding to each predetermined period, and converting the feature amount data with this time data added thereto into the corrected feature amount data.

5. The time-series data processing method according to claim 4, further comprising:
adding the time data, which is set in such a manner that, as the times of the corresponding periods are closer, the values are more similar, to the feature amount data corresponding to each predetermined period, and converting the feature amount data with this time data added thereto into the corrected feature amount data.

6. The time-series data processing method according to claim 4, further comprising:
converting the time-series data into the feature amount data per predetermined time using an autoencoder, and converting the feature amount data with the time data added thereto into the corrected feature amount data using an autoencoder.

7. The time-series data processing method according to claim 1, further comprising:
converting second time-series data measured from the measurement target into second feature amount data; and
performing processing for comparing the corrected feature amount data extracted based on the operation state information with the second feature amount data.

8. The time-series data processing method according to claim 7, further comprising:
extracting the corrected feature amount data corresponding to the time-series data associated with the selected operation state information.

9. The time-series data processing method according to claim 1, wherein
the operation state information includes information indicating an operation mode when the measurement target operates.

10. The time-series data processing method according to claim 1, further comprising:
associating the time-series data and type information indicating a type of the measurement target; and
extracting, based on the type information associated with the time-series data, the corrected feature amount data corresponding to this time-series data.

11. An information processing apparatus comprising:
a database associating time-series data measured from a measurement target and operation state information indicating an operation state of the measurement target when this time-series data is measured;
at least one memory storing processing orders; and
at least one processor configured to execute processing orders
wherein the information processing apparatus is further configured to convert the time-series data into feature amount data individually per predetermined period and convert the feature amount data into corrected feature amount data, the corrected feature amount data being generated by individually correcting the feature amount data based on a time of a corresponding period; and
extract the corrected feature amount data corresponding to the time-series data based on the operation state information associated with the time-series data.

12. The information processing apparatus according to claim 11, wherein
the at least one processor configured to execute the processing instructions converts the feature amount data corresponding to each predetermined period into the corrected feature amount data in such a manner that this corrected feature amount data, in relation to the corrected feature amount data corresponding to another period, has a value according to closeness of the time to this other period.

13. The information processing apparatus according to claim 11, wherein
the at least one processor configured to execute the processing instructions converts the feature amount data corresponding to each predetermined period into the corrected feature amount data in such a manner that this corrected feature amount data has a value more similar to the corrected feature amount data corresponding to the other period as the time is closer to the other period.

14. The information processing apparatus according to claim 11, wherein
the at least one processor configured to execute the processing instructions adds time data having a value based on the time of the corresponding period to the feature amount data corresponding to each predetermined period, and converts the feature amount data with this time data added thereto into the corrected feature amount data.

15. The information processing apparatus according to claim 14, wherein
the at least one processor configured to execute the processing instructions adds the time data, which is set in such a manner that, as the times of the corresponding periods are closer, the values are more similar, to the feature amount data corresponding to each predetermined period, and converts the feature amount data with this time data added thereto into the corrected feature amount data.

16. The information processing apparatus according to claim 14, wherein
the at least one processor configured to execute the processing instructions converts the time-series data into the feature amount data per predetermined time using an autoencoder, and converts the feature amount data with the time data added thereto into the corrected feature amount data using an autoencoder.

17. The information processing apparatus according to claim 11, wherein
the at least one processor configured to execute the processing instructions converts second time-series data measured from the measurement target into second feature amount data, and
performs processing for comparing the corrected feature amount data extracted based on the operation state information with the second feature amount data.

18. The information processing apparatus according to claim 17, wherein
the at least one processor configured to execute the processing instructions extracts the corrected feature amount data corresponding to the time-series data in association with the selected operation state information.

19. The information processing apparatus according to claim 11, wherein
the database stores data in which the time-series data and type information indicating a type of the measurement target are associated with each other, and
the at least one processor configured to execute the processing instructions extracts, based on the type information associated with the time-series data, the corrected feature amount data corresponding to this time-series data.

20. A non-transitory computer-readable storage medium storing A-a program causing an information processing apparatus to perform processing, the information processing apparatus being accessible to a database associating time-series data measured from a measurement target and operation state information indicating an operation state of the measurement target when this time-series data is measured, the processing comprising:
converting the time-series data into feature amount data individually per predetermined period and converting the feature amount data into corrected feature amount data, the corrected feature amount data being generated by individually correcting the feature amount data based on a time of a corresponding period; and
extracting the corrected feature amount data corresponding to the time-series data based on the operation state information associated with the time-series data.
